(19) United States
(12) Patent Application Publication
(10) Pub. No.: US 2005/0030411 A1
(43) Pub. Date: Feb. 10, 2005

(54) Digital still camera and image processing program

(75) Inventors: Hidehiko Aoyagi, Kawasaki-shi (JP); Masaru Muramatsu, Kawasaki-shi (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 10/902,180

(22) Filed: Jul. 30, 2004

(30) Foreign Application Priority Data
Aug. 6, 2003 (JP) 2003-206364

(51) Int. Cl. H04N 5/235; G03B 7/00

(52) U.S. Cl. 348/362

(57) ABSTRACT

A digital still camera according to the present invention can obtain an image with appropriate brightness easily without an increase in memory capacity. The digital still camera of the present invention includes: an image-capturing unit which captures a field of object to generate an image; a photometry unit which measures a luminance of a predetermined area of the field of object; a calculating unit which calculates a ratio between a luminance value of a portion of the image captured according to the luminance measured by the photometry unit, and a target luminance value of the predetermined area, the portion corresponding to the predetermined area; and a correcting unit which corrects the image generated by the image-capturing unit according to the ratio.

### CROSS REFERENCE TO RELATED APPLICATION

This application is based upon and claims the benefit of priority from Japanese Patent Application No. 2003-206364, filed on Aug. 6, 2003, the entire contents of which are incorporated herein by reference.

### BACKGROUND OF THE INVENTION

1. Field of the Invention

The present invention relates to a digital still camera which captures a field of object to generate an image, and to an image processing program for applying image processing to an image.

2. Description of the Related Art

Conventionally, a digital still camera measures the luminance of a field of object by using a photometry device or the like, and determine exposure, aperture, and other shooting conditions based on the result of measurement. Then, the digital still camera controls respective parts to achieve the determined conditions. However, errors may sometimes occur in such a control, failing to make an expected control according to the determined conditions. If the respective parts are not controlled according to the determined conditions, the resulting image may have loss of white gradation in highlight areas, loss of black gradation in shadow areas, etc.

To solve such a problem, Japanese Unexamined Patent Application Publication No. 2002-330334 has described an image capturing apparatus which estimates the amounts of error for respective possible apertures in advance for storage, and read out the stored amount of error for each aperture at the control over respective parts, thereby correcting the shutter speed, the gain of the image-capturing device, and the like in accordance with the read amount of error.

Nevertheless, it is troublesome to measure in advance the amounts of error for the respective apertures for storage as described above; moreover, it requires memories for storing them. Besides, the conditions of the aperture mechanism will change over time due to abrasion or the like, so that the amounts of errors therein may also change and become different from ones stored in advance, making the stored amounts useless.

Moreover, if the invention disclosed in the above-mentioned reference is applied to a digital still camera with interchangeable lens system, it is necessary to measure the amounts of error in advance for all of lenses and all of respective apertures for storage. Therefore, it takes more time and trouble, and memories of a larger capacity are required for storage. Furthermore, with interchangeable lens having no CPU, the digital still camera cannot specify what kind of interchangeable lens is mounted thereon.

### SUMMARY OF THE INVENTION

An object of the present invention is to provide a digital still camera which can obtain an image with proper brightness easily without an increase in memory capacity as well as an image processing program therefor.

To achieve the foregoing object, a digital still camera of the present invention includes: an image-capturing unit which captures a field of object to generate an image; a photometry unit which measures a luminance of a predetermined area of the field of object; a calculating unit which calculates a ratio between a luminance value of a portion of the image captured according to the luminance measured by the photometry unit and a target luminance value of the predetermined area; and a correcting unit which corrects the image generated by the image-capturing unit according to the ratio, the portion of the image corresponding to the predetermined area.

Moreover, to achieve the foregoing object, an image processing program of the present invention causes a computer to execute the steps of: acquiring an image to be processed and a photometry area of a field of object as a condition in which the image is captured; calculating a ratio between a luminance value of a portion of the image to be processed and a target luminance value of a predetermined area, the portion of the image corresponding to the photometric area; and correcting the image to be processed according to the ratio.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is a schematic block diagram of a digital still camera according to a first embodiment;

FIG. 2 is a functional block diagram of the digital still camera according to the first embodiment;

FIG. 3 is a diagram for explaining a photometry device;

FIG. 4 is a flowchart showing the operation of the digital still camera according to the first embodiment;

FIG. 5 shows an image-capturing device of an image-capturing unit; and

FIG. 6 is a functional block diagram of a computer according to a second embodiment.

### DESCRIPTION OF THE PREFERRED EMBODIMENTS

First Embodiment

Hereinafter, a first embodiment of the present invention will be described with reference to the drawings.

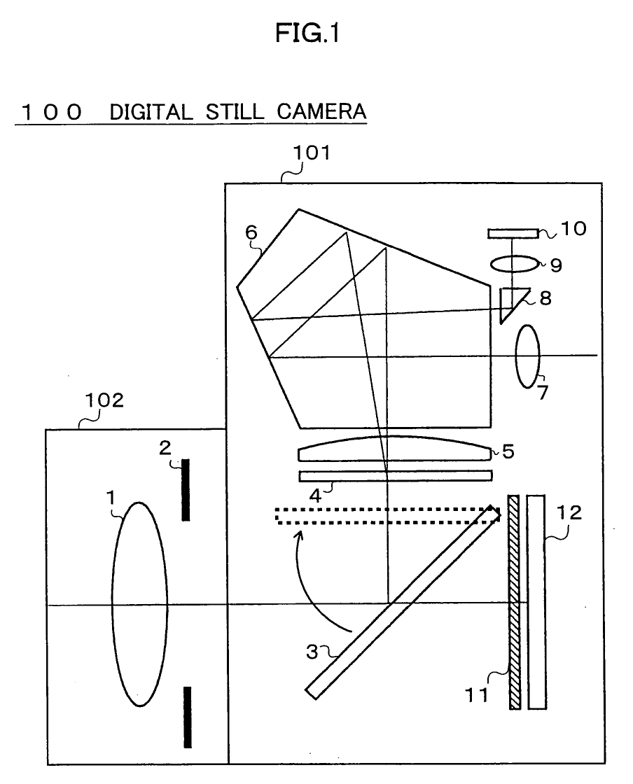

FIG. 1 is a schematic block diagram of a digital still camera 100 according to the first embodiment. The digital still camera 100 is composed of a camera body 101 and a shooting lens 102. The shooting lens 102 can be detachably mounted on the camera body 101, and has a lens 1 and an aperture stop 2 inside. Incidentally, shooting lenses other than the shooting lens 102 can also be detachably mounted on the camera body 101.

The camera body 101 is a single-lens reflex camera, including a quick return mirror 3, a diffusion screen 4 (focusing screen), a condensing lens 5, a pentaprism 6, an eyepiece 7, a photometry prism 8, a photometry lens 9, a photometry device 10, a shutter 11, and an image-capturing device 12.

During non-shooting, the quick return mirror 3 is arranged at an angle of 45° to an optical axis as shown in FIG. 1. Then, with the shooting lens 102 mounted on the camera body 101, the light beam passing through the lens 1 and the aperture stop 2 is reflected by the quick return mirror 3 and led to the eyepiece 7 via the diffusion screen 4, the condensing lens 5, and the pentaprism 6. Moreover, part of the light beam is diffused by the diffusion screen 4 and led to the photometry device 10 through the condensing lens 5, the pentaprism 6, the photometry prism 8, and the photometry lens 9.

On the other hand, at shooting, the quick return mirror 3 retreats to the position shown by the broken line to release the shutter 11. The light beam from the shooting lens 102 is led to the image-capturing device 12. The image-capturing device 12 is a photoreceptor device such as a charge coupled device (CCD).

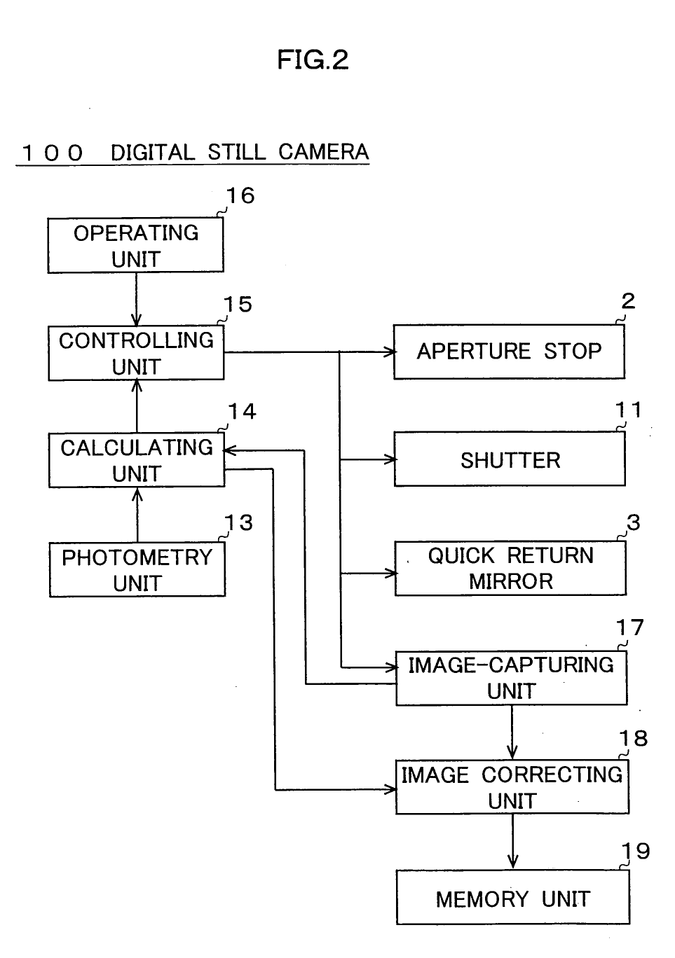

FIG. 2 is a functional block diagram of the digital still camera 100. The digital still camera 100 includes a photometry unit 13, a calculating unit 14, a controlling unit 15, an operating unit 16, an image-capturing unit 17, an image correcting unit 18, and a memory unit 19.

The photometry unit 13 includes the photometry prism 8, the photometry lens 9, and the photometry device 10 of FIG. 1. It measures luminances of the field of object, and outputs them to the calculating unit 14. The calculating unit 14 calculates parameters and the like for controlling the components (details will be given later) according to the outputs of the photometry unit 13 and of the image-capturing unit 17 to be described later, and outputs the results of calculation to the controlling unit 15 and the image correcting unit 18.

The controlling unit 15 drives the aperture stop 2, the quick return mirror 3, and the shutter 11 individually according to the results of calculation by the calculating unit 14. The operating unit 16 is provided with a release button, a setup button for a user to set an exposure compensation value (details will be given later), and so on, which are not shown. The output of the operating unit 16 is connected to the controlling unit 15.

The image-capturing unit 17 includes the image-capturing device 12 of FIG. 1. It captures the field of object through the shooting lens 102, and outputs image data to the image correcting unit 18. The image-capturing unit 17 also outputs data on the captured image to the calculating unit 14. The image correcting unit 18 corrects the image data output from the image-capturing unit 17 according to the results of calculation of the calculating unit 14 (details will be given later), and outputs the resultant to the memory unit 19.

The memory unit 19 is a recording medium such as a memory card (card-like removable memory). It records thereon the image data corrected by the image correcting unit 18. The memory unit 19 may be an internal memory.

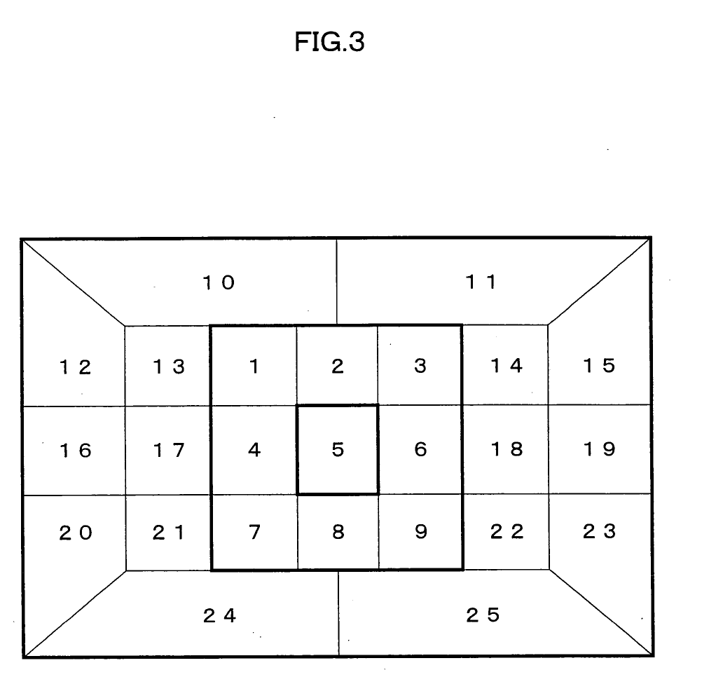

The photometry device 10 included in the photometry unit 13 is a photoreceptor device such as a silicon photo diode (SPD) and a CCD, and corresponds to a multi-area photometry sensor shown in FIG. 3. The photometry device 10 divides the field of object into 25 areas and makes photometry of almost the entire field to obtain respective values BV(1) to BV(25) of the areas. The digital still camera 100 has three photometry modes as to the photometry using such a photometry device 10. The three photometry modes, namely, are a centerweighted photometry mode, a spot photometry mode, and a multi-area photometry mode. These photometry modes are set by the user through the operating unit 16.

Incidentally, the lens 1, the aperture stop 2, the quick return mirror 3, the shutter 11, the image-capturing device 12, and the controlling unit 15 correspond to the image-capturing unit in claims. The photometry prism 8, the photometry lens 9, the photometry device 10, and the photometry unit 13 correspond to the photometry unit in claims. The calculating unit 14 corresponds to the calculating unit in claims. The image correcting unit 18 corresponds to the correcting unit in claims. The controlling unit 15 and the operating unit 16 correspond to the setup unit in claims. Moreover, the individual areas of the photometry device 10 in FIG. 3 correspond to the plurality of areas in claims.

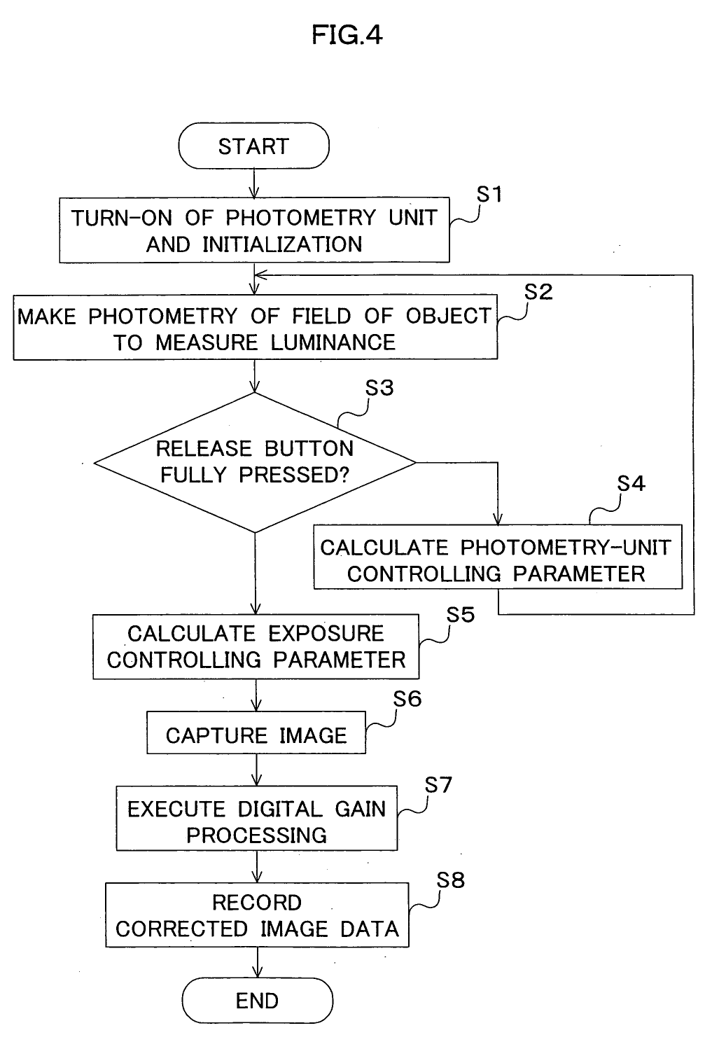

With reference to the flowchart shown in FIG. 4, description will be given of the shooting operations of the digital still camera 100 having the configuration described above. The series of operations in the flowchart of FIG. 4 is started upon the not-shown release button pressed halfway.

When the not-shown release button is pressed halfway by the user, at step S1, the digital still camera 100 turns on the photometry device 10 of the photometry unit 13 and performs a predetermined initializing operation.

At step S2, the photometry device 10 of the photometry unit 13 makes photometry of the field of object through the photometry prism 8 and the photometry lens 9, thereby obtaining luminances. Here, the photometry unit 13 performs photometry in compliance with the photometry mode set by the user.

When the user sets the centerweighted photometry mode, the photometry device 10 of the photometry unit 13 makes photometry of the areas 1 to 9 which fall generally on around center of the photometry device in FIG. 3, and obtains the luminance values BV(1) to BV(9). When the user sets the spot photometry mode, the photometry unit 13 makes photometry of the spot area 5 which is a central area of the photometry device in FIG. 3, and obtains the luminance value BV(5). When the user sets the multi-area photometry mode, the photometry device 10 of the photometry unit 10 makes photometry of the entire areas 1-25 of the photometry device in FIG. 3, and obtains the luminance values BV(1) to BV(25). The areas to be measured in each photometry mode correspond to the predetermined area in claims. Note that which areas to measure during each of set photometry modes is not limited to this example.

At step S3, the controlling unit 15 determines whether or not the not-shown release button is fully pressed by the user. If not fully pressed, the processing moves to step S4. If fully pressed, the processing moves to step S5.

At step S4, when the not-shown release button is not fully pressed by the user, the calculating unit 14 calculates photometry-unit controlling parameters.

The photometry-unit controlling parameters represent photometry conditions in the photometry unit 13, an amplifier gain when the photometry device 10 of the photometry unit 13 is an SPD, and an amplifier gain and a storing time when the photometry device 10 is a CCD. The calculating unit 14 calculates the photometry-unit controlling parameters, and outputs them to the photometry unit 13.

At step S4, the calculating unit 14 determines the condition for the next photometry based on the result of the photometry at step S2. This makes it possible for the photometry unit 13 to perform optimum photometry for the current camera situation.

The digital still camera 100 repeats the photometry and the calculation of the photometry-unit controlling parameters until the not-shown release button is fully pressed by the user (YES at step S3). Upon the full press on the not-shown release button by the user, the processing moves to step S5.

At step S5, upon the full press on the not-shown release button by the user, the calculating unit 14 calculates exposure controlling parameters. The exposure controlling parameters represent a shutter speed and an aperture. The calculating unit 14 initially calculates a representative luminance value according to the luminance values measured by the photometry unit 13, and calculates the exposure controlling parameters according to the representative luminance value. The representative luminance value is representative of values of a plurality of photometry areas to be measured, with the individual luminance values measured by the photometry unit 13 taken into consideration.

The calculating unit 14 initially calculates the representative luminance value according to the luminance values which the photometry unit 13 has measured in compliance with the current photometry mode. When the centerweighted photometry mode is set by the user, the calculating unit 14 calculates a representative luminance value BVcw in the centerweighted photometry mode based on the luminance values BV(1) to BV(9). When the spot photometry mode is set by the user, the calculating unit 14 calculates a representative luminance value BVsp in the spot photometry mode based on the luminance value BV(5). Moreover, when the multi-area photometry mode is set, the calculating unit 14 calculates a representative luminance value BVa in the multi-area photometry mode based on the luminance values BV(1) to BV(25), and also calculates the luminance value BVcw based on the luminance values BV(1) to BV(9) as in the centerweighted photometry mode.

These representative luminance values (BVcw, BVsp, BVa) are calculated, for example, by the same methods as disclosed in Japanese Unexamined Patent Application Publication Nos. Hei 9-281543 and Sho 63-170628.

Next, the calculating unit 14 calculates the shutter speed and the aperture as the exposure controlling parameters, according to the calculated representative luminance value. The calculating unit 14 has in advance arithmetic expressions for calculating the shutter speed and the aperture according to the representative luminance value. Then, the calculating unit 14 outputs the shutter speed and the aperture calculated to the controlling unit 15 as the exposure controlling parameters.

At step S6, the controlling unit 15 and the image-capturing unit 17 capture the field of object. The controlling unit 15 controls the aperture stop 2, the shutter 11, and the quick return mirror 3 in accordance with the shutter speed and the aperture calculated by the calculating unit 14. The image-capturing unit 17 captures the field of object. Here, it is assumed that there is some error in the controlling unit 15's control over the aperture stop 2 and the shutter 11. Then, to reduce this error, at step S7 the calculating unit 14 and the image correcting unit 18 perform digital gain processing.

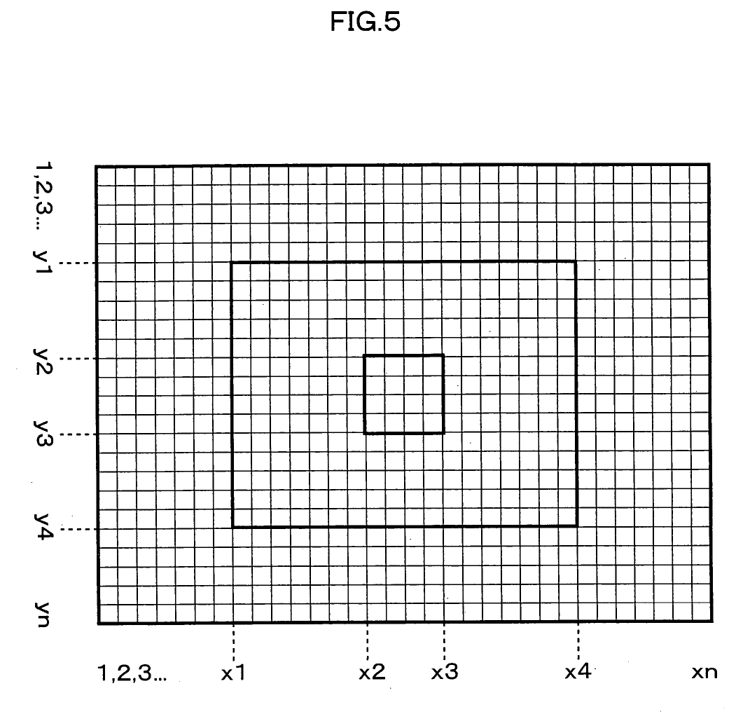

FIG. 5 shows an image-capturing device of the image-capturing unit 17. Each single cell in FIG. 5 corresponds to a pixel of the image-capturing device 12. From each of the pixels image data on a red component (R component), a green component (G component), and a blue component (B component) are outputted to an image correcting unit 18.

Initially, the calculating unit 14 determines the luminance values Y of the respective pixels by using the following equation:
Y[i,j]=Kr×Dr[i,j]+Kg×Dg[i,j]+Kb×Db[i,j] (Eq. 1)

In Eq. 1, i and j indicate pixel numbers. Dr is the image data on the R component, Dg the image data on the G component, and Db the image data on the B component. Kr, Kg, and Kb are predetermined coefficients for determining a luminance value from the image data.

Next, the calculating unit 14 and the image correcting unit 18 correct the image data in compliance with the photometry mode set by the user.

(1) In Centerweighted Photometry Mode

The calculating unit 14 corrects the image data output from the image-capturing unit 17 by using the following equation:
DA=DB×{(TgY×2^{H})/AveYcw} (Eq. 2)

In Eq. 2, DA is the corrected image data, and DB is the image data (yet to be corrected) output from the image-capturing unit 17. TgY is a predetermined luminance value which is a basis for the target luminance value to be described later in detail. H is an exposure compensation value. AveYcw is the average of luminance values of a portion of the image data output from the image-capturing unit 17, the portion corresponding to the areas to be measured by the photometry unit 13. AveYcw is calculated by using the following equation:
AveYcw=(ΣY[i,j])/{(x4−x1+1)×(y4−y1+1)} (Eq. 3)

In Eq. 3, i=x1 to x4 and j=y1 to y4. The data on the area, i=x1 to x4 and j=y1 to y4 is a portion of the image data output from the image-capturing unit 17, the portion corresponding to the areas to be measured in the centerweighted photometry mode (areas 1-9 in FIG. 3). The average of the luminance values of this portion of the image data is calculated By Eq. 3.

TgY in Eq. 2 is a luminance value which is determined in advance such that image data obtained from a uniformly gray (halftone) subject appear in preferable gray, i.e. is reproduced in halftone. The exposure compensation value H is set by the user via the operating unit 16. For example, the user can compensate the exposure as he/she likes by shifting this compensation value by +1 or −2 from the proper exposure to a brighter side or dimmer side. This exposure compensation value corresponds to the condition for exposure compensation in claims.

Note that (TgY×2^{H}) in Eq. 2 corresponds to the target luminance value in claims. In Eq. 2, TgY is multiplied by 2^{H so as to reflect the user's intended exposure in the correction.}

By the correction using Eq. 2, with the luminance value (AveYcw) obtained from the image data smaller than (TgY×2^{H}), the entire image can be corrected to have a brighter color. With the luminance value (AveYcw) obtained from the image data greater than (TgY×2^{H}), the entire image can be corrected to have a dimmer color.

(2) In Spot Photometry Mode

The calculating unit 14 corrects the image data output from the image-capturing unit 17 by using the following equation:
DA=DB×{(TgY×2^{H})/AveYsp} (Eq. 4)

In Eq. 4, DA is the corrected image data, and DB is the image data (yet to be corrected) output from the image-capturing unit 17. TgY and H are the same as those in the centerweighted photometry mode. AveYsp is the average of luminance values of a portion of the image data output from the image-capturing unit 17, the portion corresponding to the area to be measured by the photometry unit 13. AveYsp is calculated by the following equation:
AveYsp=(ΣY[i,j])/{(x3−x2+1)×(y3−y2+1)} (Eq. 5)

In Eq. 5, i=x2 to x3 and j=y2 to y3. The data on the area, i=x2 to x3 and j=y2 to y3 is a portion of the image data output from the image-capturing unit 17, the portion corresponding to the area to be measured in the spot photometry mode (area 5 in FIG. 3). By Eq. 5, the average of the luminance values of this portion of the image data is calculated.

Note that (TgY×2^{H}) in Eq. 4 corresponds to the target luminance value in claims. In Eq. 4, TgY is multiplied by 2^{H} for the same reason as described in (1). By the correction using Eq. 4, with the luminance value (AveYsp) obtained from the image data smaller than (TgY×2^{H}), the entire image can be corrected to have a brighter color. With the luminance value (AveYsp) obtained from the image data greater than (TgY×2^{H}), the entire image can be corrected to have a dimmer color.

(3) In Multi-Area Photometry Mode

The calculating unit 14 corrects the image data output from the image-capturing unit 17 by using the following equation:
DA=DB×{(TgM×2^{H})/AveYcw} (Eq. 6)

In Eq. 6, DA is the corrected image data, and DB is the image data (yet to be corrected) output from the image-capturing unit 17. H is the same as that in the centerweighted photometry mode. In the multi-area photometry mode, the entire image corresponds to the areas to be measured by the photometry unit 13. Nevertheless, as in Eq. 6, for the correction used is not the average of the luminance values of the entire image data but AveYcw described in (1), Eq. 3.

TgM is a luminance value which is a basis for the target luminance value in the multi-area photometry mode. TgM is calculated by the following equation:
TgM=TgY×2^{(BVcw-BVa)}. (Eq. 7)

In Eq. 7, TgY is the same as that described in the centerweigted and spot photometry modes. BVcw is the same luminance value as the representative luminance value in the centerweighted photometry mode. BVa is the representative luminance value in the multi-area photometry mode. BVcw corresponds to the luminance of the first area in claims. BVa corresponds to the luminance of the second area in claims.

Note that (TgM×2^{H}) in Eq. 6 corresponds to the target luminance value in claims. In Eq. 6, TgM is multiplied by 2^{H} for the same reason as described in (1). By the correction using Eq. 6, with the luminance value (AveYcw) obtained from the image data smaller than (TgM×2^{H}), the entire image can be corrected to have a brighter color. With the luminance value (AveYcw) obtained from the image data greater than the target luminance value (TgM×2^{H}), the entire image can be corrected to have a dimmer color.

At step S8, the memory unit 19 records thereon the image data corrected by the image correcting unit 18 as described above and terminates the series of processing. According to the first embodiment as has been described, luminances are measured of the area(s) of the field of object corresponding to the photometry mode (predetermined area in claims), and a ratio is calculated between the luminance value of the portion of the image output from the image-capturing unit 17 corresponding to the predetermined area(s) and the predetermined target luminance value. The image data output from the image-capturing unit 17 is corrected based on the ratio.

This eliminates the need to measure the amounts of error in advance for storage. It is therefore possible to obtain an image with appropriate brightness easily without an increase in memory capacity. Moreover, even with a camera with interchangeable lens system such as described in the first embodiment, an image with appropriate brightness is obtainable easily without an increase in memory capacity.

According to the first embodiment, in the multi-area photometry mode, TgM (the luminance value as a basis for the target luminance value) is determined from the representative luminance value BVa in the multi-area photometry mode (the luminance of the second area) and the luminance value BVcw calculated as in the centerweighted photometry mode (the luminance of the first area of the field of object) (see Eq. 7). Then, an image with appropriate brightness is obtainable by making the correction using this target luminance value.

According to the first embodiment, in the multi-area photometry mode, determining the target luminance value according to the luminance value BVa as a representative value of the luminances of a plurality of areas makes it possible to obtain an image with appropriate brightness easily.

According to the first embodiment, the target luminance value is determined based on the exposure value (condition for exposure compensation) set by the user. It is therefore possible to reflect the user's intended exposure in the target luminance value as well as to obtain an image with appropriate brightness easily without an increase in memory capacity.

The first embodiment has dealt with the case where the fixed luminance value TgY is used as the reference luminance value for the target luminance value in the centerweighted photometry mode and the spot photometry mode. Nevertheless, the luminance value may be modified as appropriate, for example, in accordance with a white balance mode.

Second Embodiment

Hereinafter, a second embodiment of the present invention will be described in detail with reference to the drawings. The same functional blocks as those of the first embodiment will be described below by using the same reference numbers as in the first embodiment.

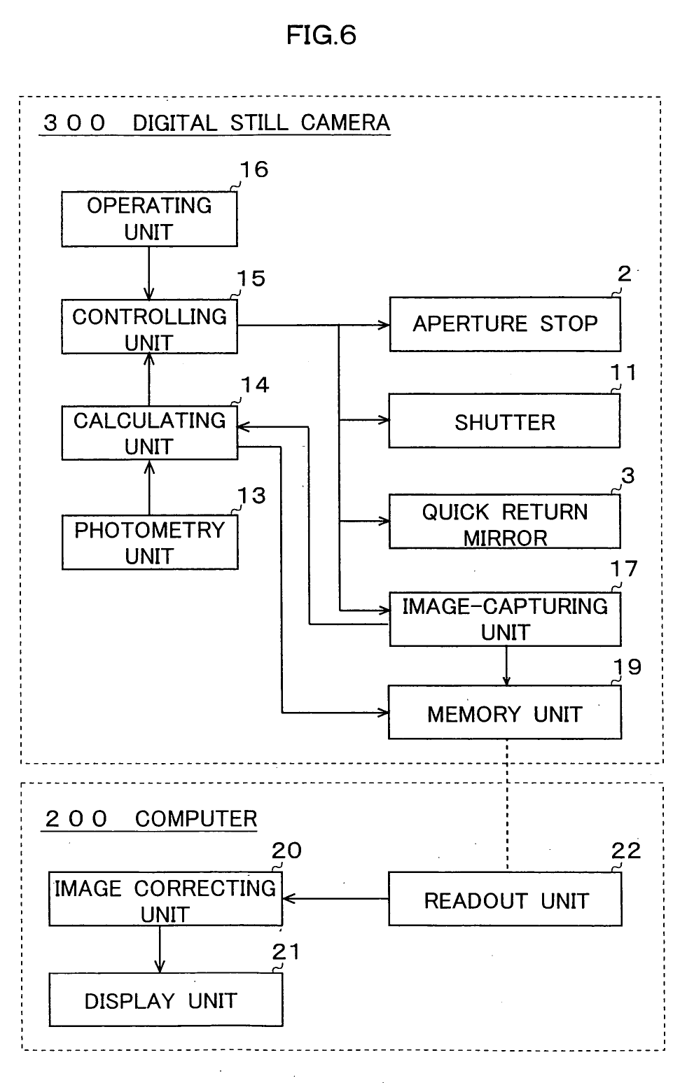

FIG. 6 is a functional block diagram of a computer 200 according to the second embodiment. As shown in FIG. 6, the computer 200 includes an image correcting unit 20 and a display unit 21, as well as a readout unit 22 which can receive data and the like from exterior. An image processing program of the present invention is stored in the computer 200 in advance. According to this image processing program, the computer 200 performs image correction.

In FIG. 6, the computer 200 is connected to an external digital still camera 300 through the readout unit 22. The computer 200 acquires image data captured by the digital still camera 300, corrects the image data in the image correcting unit 20 through the steps described with reference to FIG. 4, and displays the resultant onto the display unit 21. Since the same correction method as in the first embodiment is used here, description thereof will be omitted.

However, the computer 200 also acquires, for instance, the photometry areas of the field of object as the conditions in which the image is captured, in addition to the image data obtained by image capturing (the image to be processed). The conditions are corrected by the same manner as described in the first embodiment with reference to FIG. 4.

The conditions in which the image is captured may be recorded as additional information on the image data, using such a file format as EXIF. The computer 200 may acquire the image to be processed not from the digital still camera 300 but from a memory card or other recording media.

As has been described, the second embodiment can provide the same effects as those of the first embodiment.

The second embodiment has dealt with the case where the correction is made through the steps as those in the flowchart of FIG. 4 according to the first embodiment. However, the computer 200 may perform only some of the steps shown in the flowchart of FIG. 4.

The invention is not limited to the above embodiments and various modifications may be made without departing from the spirit and scope of the invention. Any improvement may be made in part or all of the components.

1. A digital still camera comprising:
an image-capturing unit which captures a field of object to generate an image;
a photometry unit which measures a luminance of a predetermined area of said field of object;
a calculating unit which calculates a ratio between a luminance value of a portion of an image captured according to the luminance measured by said photometry unit and a target luminance value of the predetermined area, the portion corresponding to the predetermined area; and
a correcting unit which corrects the image generated by said image-capturing unit according to the ratio.

2. The digital still camera according to claim 1, wherein
said calculating unit determines the target luminance value according to a luminance of a first area of the field of object measured by said photometry unit and to a luminance of a second area different from the first area, and calculates a ratio between a luminance value of a portion of the image and the determined target luminance value, the portion of the image corresponding to the first area.

3. The digital still camera according to claim 1, wherein:
said photometry unit divides the field of object into a plurality of areas and performs photometry of the plurality of areas, thereby measuring a luminance of each of the plurality of areas; and
said calculating unit determines the target luminance value according to a representative value and the luminance of the predetermined area measured by said photometry unit, and calculates a ratio between the luminance value of the portion corresponding to the predetermined area and the determined target luminance value, the representative value being obtained according to the luminance of each of the plurality of areas measured by said photometry unit.

4. The digital still camera according to claim 1, comprising
a setup unit which sets a condition for exposure compensation at a time when the image-capturing unit captures an image, and wherein
said calculating unit determines said target luminance value based on the condition for exposure compensation.

5. An image processing program which causes a computer to execute the steps of:
acquiring an image to be processed and a photometry area of a field of object as an imaging condition in which the image is captured;
calculating a ratio between a luminance value of a portion of the image to be processed and a predetermined target luminance value, the portion corresponding to the photometric area; and
correcting the image to be processed according to the ratio.

6. The image processing program according to claim 5, comprising
acquiring a luminance of the photometry area as the imaging condition, and wherein
in the calculation step, the target luminance value is determined according to a luminance of a first area of the field of object and to a luminance of a second area different from the first area, and a ratio between a luminance value of a portion of the image to be processed and the determined target luminance value is calculated, the portion corresponding to the first area.

7. The image processing program according to claim 5, comprising
dividing the field of object into a plurality of areas and performing photometry of each of the plurality of areas when capturing the image to be processed, and acquiring a luminance of each of the plurality of areas as the imaging condition, and wherein
in the calculation step, the target luminance value is determined according to a representative value and a luminance of the photometry area acquired in the luminance acquiring step, and a ratio between a luminance value of a portion of the image to be processed and the determined target luminance value is calculated, the representative value being obtained according to the luminance of each of the plurality of areas, the portion corresponding to the photometry area acquired in the photometry area acquiring step.

8. The image processing program according to claim 5, comprising
acquiring a condition for exposure compensation as the imaging condition, and wherein
in the calculation step, the target luminance value is determined based on the condition for exposure compensation.
